(19) United States
(12) Patent Application Publication
(10) Pub. No.: US 2024/0185220 A1
(43) Pub. Date: Jun. 6, 2024

(54) TWO PAYMENT ACCOUNT NUMBERS IN ONE CARD

(71) Applicant: Visa International Service Association, San Francisco, CA (US)

(72) Inventor: Anshul Kumar AGARWAL, Tampines (SG)

(73) Assignee: Visa International Service Association, San Francisco, CA (US)

(21) Appl. No.: 18/061,458

(22) Filed: Dec. 3, 2022

(51) Int. Cl. G06Q 20/34; G06K 19/07

(52) U.S. Cl. CPC G06Q 20/3572; G06K 19/0723

(57) ABSTRACT

The present disclosure provides a payment card comprising two discrete or more payment accounts associated with primary account numbers (PANs). Each PAN comprises a magnetic strip, EMV chip, CCV, and contactless payment circuit. The contactless payment circuits wirelessly transmit PAN information to a point-of-sale (POS) terminal enabling an end-user engage in a payment transaction with a merchant. The payment card further comprises two switches, a first switch on a first side of the payment card associated with a first contactless payment circuit and a second switch on a second side of the payment card associated with a second contactless payment circuit. The first switch and second switch are configured to detect a user input by an end-user and dynamically activate the first contactless payment circuit associated with the first PAN or the second contactless payment circuit associated with the second PAN.

### TECHNICAL FIELD

The present disclosure describes a single payment card comprising multiple payment accounts. More particularly, the present disclosure describes a single payment card comprising two different primary account numbers.

### SUMMARY

In one aspect, the present disclosure provides a payment card comprising: a first side associated with a first payment account; a second side associated with a second payment account; the first side comprising: a first primary account number (PAN) information is associated with the first payment account and displayed on a first side of the payment card, wherein the first PAN information corresponds to an end-user; a second magnetic strip corresponding to the second payment account; a first EMV (Europay, Mastercard, Visa) chip corresponding to the first PAN; and a first switch corresponding to a first contactless payment circuit for the first PAN, wherein the first contactless payment circuit is an open circuit at the first switch, wherein the first switch is configurable to electrically complete the first contactless payment circuit of the first payment account; the second side comprising: a second PAN information is associated with the second payment account and displayed on a second side of the payment card, wherein the second PAN information corresponds to the end-user; a first magnetic strip corresponding to the first payment account; a second EMV chip corresponding to the second PAN; and a second switch corresponding to a second contactless payment circuit for the second PAN, wherein the second contactless payment circuit is an open-circuit at the second switch, and wherein the second switch is configurable to electrically complete the second contactless payment circuit of the second payment account.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The [apparatuses, systems, and methods] disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIGS. 1A and 1B illustrate a single payment card comprising two payment accounts, according to at least one aspect of the present disclosure.

FIGS. 2A and 2B illustrate an end-user activating respective contactless payment circuits through switches, according to at least one aspect of the present disclosure.

FIG. 3A illustrate a first short edge view of a first side of a payment card with embossed contact points, according to at least one aspect of the present disclosure.

FIG. 3B illustrate a second short edge view of a second side of a payment card with embossed contact points, according to at least one aspect of the present disclosure.

FIG. 4 illustrates a long edge view of a payment card with embossed contact points for switches in contactless payment circuits, according to at least one aspect of the present disclosure.

FIG. 5A illustrate a first short edge view of a first side of a payment card with flush or recessed contact points, according to at least one aspect of the present disclosure.

FIG. 5B illustrate a second short edge view of a second side of a payment card 300 with flush or recessed contact points, according to at least one aspect of the present disclosure.

FIG. 6 illustrates a long edge view of a payment card with flush or recessed contact points for switches in contactless payment circuits, according to at least one aspect of the present disclosure.

### DESCRIPTION

The following disclosure may provide exemplary systems, devices, and methods for conducting a financial transaction and related activities. Although reference may be made to such financial transactions in the examples provided below, aspects are not so limited. That is, the systems, methods, and apparatuses may be utilized for any suitable purpose.

Before discussing specific embodiments, aspects, or examples, some descriptions of terms used herein are provided below.

“Account credentials” may include any information that identifies an account and allows a payment processor to verify that a device, person, or entity has permission to access the account. For example, account credentials may include an account identifier (e.g., a PAN), a token (e.g., account identifier substitute), an expiration date, a cryptogram, a verification value (e.g., card verification value (CVV)), personal information associated with an account (e.g., address, etc.), an account alias, or any combination thereof. Account credentials may be static or dynamic such that they change over time. Further, in some embodiments or aspects, the account credentials may include information that is both static and dynamic. For example, an account identifier and expiration date may be static but a cryptogram may be dynamic and change for each transaction. Further, in some embodiments or aspects, some or all of the account credentials may be stored in a secure memory of a user device. The secure memory of the user device may be configured such that the data stored in the secure memory may not be directly accessible by outside applications and a payment application associated with the secure memory may be accessed to obtain the credentials stored on the secure memory. Accordingly, a mobile application may interface with a payment application in order to gain access to payment credentials stored on the secure memory.

Further, the term “account credential,” “account number,” or “payment credential” may refer to any suitable information associated with an account (e.g., a payment account and/or payment device associated with the account). Such information may be directly related to the account or may be derived from information related to the account. Examples of account information may include a PAN (primary account number or “account number”), user name, expiration date, CVV (card verification value), dCVV (dynamic card verification value), CVV2 (card verification value 2), CVC3 card verification values, etc. Payment credentials may be any information that identifies or is associated with a payment account. Payment credentials may be provided in order to make a payment from a payment account. Payment credentials can also include a user name, an expiration date, a gift card number or code, and any other suitable information.

As used herein, the terms “client” and “client device” may refer to one or more client-side devices or systems (e.g., remote from a transaction service provider) used to initiate or facilitate a transaction (e.g., a payment transaction). Moreover, a “client” may also refer to an entity (e.g., a merchant, an acquirer, and/or the like) that owns, utilizes, and/or operates a client device for initiating transactions (e.g., for initiating transactions with a transaction service provider).

The terms “client device” and “user device” may refer to any electronic device that is configured to communicate with one or more servers or remote devices and/or systems. A client device or a user device may include a mobile device, a network-enabled appliance (e.g., a network-enabled television, refrigerator, thermostat, and/or the like), a computer, a POS system, and/or any other device or system capable of communicating with a network. A client device may further include a desktop computer, laptop computer, mobile computer (e.g., smartphone), a wearable computer (e.g., a watch, pair of glasses, lens, clothing, and/or the like), a cellular phone, a network-enabled appliance (e.g., a network-enabled television, refrigerator, thermostat, and/or the like), a point-of-sale (POS) system, and/or any other device, system, and/or software application configured to communicate with a remote device or system.

As used herein, the term “communication” and “communicate” may refer to the reception, receipt, transmission, transfer, provision, and/or the like of information (e.g., data, signals, messages, instructions, calls, commands, and/or the like). A communication may use a direct or indirect connection and may be wired and/or wireless in nature. As an example, for one unit (e.g., a device, a system, a component of a device or system, combinations thereof, and/or the like) to communicate with another unit means that the one unit is able to directly or indirectly receive information from and/or transmit information to the other unit. The one unit may communicate with the other unit even though the information may be modified, processed, relayed, and/or routed between the one unit and the other unit. In one example, a first unit may communicate with a second unit even though the first unit receives information and does not communicate information to the second unit. For example, a first unit may be in communication with a second unit even though the first unit passively receives data and does not actively transmit data to the second unit. As another example, a first unit may communicate with a second unit if an intermediary unit (e.g., a third unit located between the first unit and the second unit) receives information from the first unit, processes the information received from the first unit to produce processed information, and communicates the processed information to the second unit. In some non-limiting embodiments or aspects, a message may refer to a packet (e.g., a data packet, a network packet, and/or the like) that includes data. It will be appreciated that numerous other arrangements are possible.

As used herein, the term “comprising” is not intended to be limiting, but may be a transitional term synonymous with “including,” “containing,” or “characterized by.” The term “comprising” may thereby be inclusive or open-ended and does not exclude additional, unrecited elements or method steps when used in a claim. For instance, in describing a method, “comprising” indicates that the claim is open-ended and allows for additional steps. In describing a device, “comprising” may mean that a named element(s) may be essential for an embodiment or aspect, but other elements may be added and still form a construct within the scope of a claim. In contrast, the transitional phrase “consisting of” excludes any element, step, or ingredient not specified in a claim. This is consistent with the use of the term throughout the specification.

As used herein, the term “computing device” or “computer device” may refer to one or more electronic devices that are configured to directly or indirectly communicate with or over one or more networks. A computing device may be a mobile device, a desktop computer, and/or the like. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may not be a mobile device, such as a desktop computer. Furthermore, the term “computer” may refer to any computing device that includes the necessary components to send, receive, process, and/or output data, and normally includes a display device, a processor, a memory, an input device, a network interface, and/or the like.

Reference to “a device,” “a server,” “a processor,” and/or the like, as used herein, may refer to a previously recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

An “end-user” may include any application, consumer, process, or system that is configured to interact with a requestor for tokenization/de-tokenization/token management services or payment services and systems that may operate using tokenization/de-tokenization/token management services. For example, an end-user may include a consumer, a merchant, a mobile device, or any other suitable entity that may be associated with a requestor in the network token system.

As used herein, “identification information” may include any suitable information associated with an account (e.g., a payment account and/or payment device associated with the account). Such information may be directly related to the account or may be derived from information related to the account. Examples of account information may include a PAN (primary account number or “account number”), user name, expiration date, CVV (card verification value), dCVV (dynamic card verification value), CVV2 (card verification value 2), CVC3 card verification values, etc. CVV2 is generally understood to be a static verification value associated with a payment device. CVV2 values are generally visible to a user (e.g., a consumer), whereas CVV and dCVV values are typically embedded in memory or authorization request messages and are not readily known to the user (although they are known to the issuer and payment processors).

An “issuer” can include a payment account issuer. The payment account (which may be associated with one or more payment devices) may refer to any suitable payment account (e.g., credit card account, a checking account, a savings account, a merchant account assigned to a consumer, or a prepaid account), an employment account, an identification account, an enrollment account (e.g., a student account), etc.

As used herein, the term “merchant” may refer to one or more individuals or entities (e.g., operators of retail businesses) that provide goods and/or services, and/or access to goods and/or services, to a user (e.g., a customer, a consumer, a customer of the merchant, and/or the like) based on a transaction (e.g., a payment transaction)). As used herein “merchant system” may refer to one or more computer systems operated by or on behalf of a merchant, such as a server computer executing one or more software applications.

As used herein, a “payment account” (which may be associated with one or more payment devices) may refer to any suitable payment account including a credit card account, a checking/debit account, or a prepaid account.

A “payment device” may refer to any device that may be used to conduct a financial transaction, such as to provide payment information to a merchant. A payment device may be in any suitable form. The payment device may be a software object, a hardware object, or a physical object. As examples of physical objects, the payment device may comprise a substrate such as a paper or plastic card, and information that is printed, embossed, encoded, or otherwise included at or near a surface of an object. A hardware object can relate to circuitry (e.g., permanent voltage values), and a software object can relate to non-permanent data stored on a device. For example, suitable payment devices can be hand-held and compact so that they can fit into a consumer's wallet and/or pocket (e.g., pocket-sized). They may include smart cards, debit devices (e.g., a debit card), credit devices (e.g., a credit card), stored value devices (e.g., a stored value card or “prepaid” card), magnetic stripe cards, keychain devices (such as the Speedpass™ commercially available from Exxon-Mobil Corp.), etc. Other examples of payment devices include cellular or wireless telephones (e.g., a smartphone), personal digital assistants (PDAs), portable computers (e.g,. tablets or laptop computers), pagers, payment cards, security cards, access cards, smart media, transponders, 2-D barcodes, electronic or digital wallets, and the like. If the payment device is in the form of a debit, credit, or smartcard, the payment device may also optionally have features such as magnetic stripes or EMV chips. Such devices can operate in either a contact or contactless mode. In some non-limiting embodiments or aspects, a payment device may include an electronic payment device, such as a smartcard, a chip card, integrated circuit card, and/or the like. An electronic payment device may include an embedded integrated circuit and the embedded integrated circuit may include a data storage medium (e.g., volatile and/or non-volatile memory) to store information associated with the payment device, such as an account identifier, a name of the account holder, and/or the like. The payment device may interface with an access device such as a point-of-sale device to initiate the transaction. In some embodiments or aspects, a mobile device can function as a payment device (e.g., a mobile device can store and be able to transmit payment credentials for a transaction). Further, a payment device may be associated with a value such as a monetary value, a discount, or store credit, and a payment device may be associated with an entity such as a bank, a merchant, a payment processing network, and/or a person. A payment device may be used to make a payment transaction.

The terms “point-of-sale system,” “POS system,” or “POS terminal,” as used herein, may refer to one or more computers and/or peripheral devices used by a merchant to engage in payment transactions with customers, including one or more card readers, near-field communication (NFC) receivers, radio-frequency identification (RFID) receivers, and/or other contactless transceivers or receivers, contact-based receivers, payment terminals, computers, servers, input devices, and/or other like devices that can be used to initiate a payment transaction. A POS terminal may be located proximal to a user, such as at a physical store location, or a POS terminal may be remote from the user, such as a server interacting with a user browsing on their personal computer. POS terminals may include mobile devices.

A “primary account number (PAN)” may be a variable length, (e.g., 13 to 19-digit) industry standard-compliant account number that is generated within account ranges associated with a BIN by an issuer.

As used herein, “short range communication” or “short range wireless communication” may comprise any method of providing short-range contact or contactless communications capability, such as NFC, RFID, Bluetooth™, infra-red, or other data transfer capability that can be used to exchange data between a payment device and an access device. In some embodiments or aspects, short range communications may be in conformance with a standardized protocol or data transfer mechanism (e.g., ISO 14443/NFC). Short range communication typically comprises communications at a range of less than 2 meters. In some embodiments or aspects, it may be preferable to limit the range of short-range communications (e.g. to a range of less than 1 meter, less than 10 centimeters, or less than 2.54 centimeters) for security, technical, and/or practical considerations. For instance, it may not be desirable for a POS terminal to communicate with every payment device that is within a 2 meter radius because each of those payment devices may not be involved in a transaction, or such communication may interfere with a current transaction involving different financial transaction devices. Typically the payment device or the access device also includes a protocol for determining resolution of collisions (e.g., when two payment devices are communicating with the access device simultaneously). The use of short-range communications may be used when the merchant and the consumer are in close geographic proximity, such as when the consumer is at the merchant's place of business.

As used herein, the term “system” may refer to one or more computing devices or combinations of computing devices (e.g., processors, servers, client devices, software applications, components of such, and/or the like).

The term “transaction data” may include any data associated with one or more transactions. In some embodiments or aspects, the transaction data may merely include an account identifier (e.g., a PAN) or payment token. Alternatively, in other embodiments or aspects, the transaction data may include any information generated, stored, or associated with a merchant, consumer, account, or any other related information to a transaction. For example, transaction data may include data in an authorization request message that is generated in response to a payment transaction being initiated by a consumer with a merchant. Alternatively, transaction data may include information associated with one or more transactions that have been previously processed and the transaction information has been stored on a merchant database or other merchant computer. The transaction data may include an account identifier associated with the payment instrument used to initiate the transaction, consumer personal information, products or services purchased, or any other information that may be relevant or suitable for transaction processing. Additionally, the transaction information may include a payment token or other tokenized or masked account identifier substitute that may be used to complete a transaction and protect the underlying account information of the consumer.

As used herein, the term “transaction service provider” may refer to an entity that receives transaction authorization requests from merchants or other entities and provides guarantees of payment, in some cases through an agreement between the transaction service provider and an issuer. For example, a transaction service provider may include a payment network, such as Visa®, MasterCard®, American Express®, or any other entity that processes transactions. As used herein “transaction service provider system” may refer to one or more systems operated by or operated on behalf of a transaction service provider, such as a transaction service provider system executing one or more software applications associated with the transaction service provider. In some non-limiting embodiments or aspects, a transaction processing system may include one or more server computers with one or more processors and, in some non-limiting embodiments or aspects, may be operated by or on behalf of a transaction service provider.

A “user” may include an individual. In some embodiments or aspects, a user may be associated with one or more personal accounts and/or mobile devices. The user may also be referred to as a cardholder, account holder, or consumer.

A “user device” is an electronic device that may be transported and/or operated by a user. A user device may provide remote communication capabilities to a network. The user device may be configured to transmit and receive data or communications to and from other devices. In some embodiments or aspects, the user device may be portable. Examples of user devices may include mobile phones (e.g., smart phones, cellular phones, etc.), PDAs, portable media players, wearable electronic devices (e.g. smart watches, fitness bands, ankle bracelets, rings, earrings, etc.), electronic reader devices, and portable computing devices (e.g., laptops, netbooks, ultrabooks, etc.). Examples of user devices may also include automobiles with remote communication capabilities.

“User information” may include any information that is associated with a user. For example, the user information may include a device identifier of a device that the user owns or operates and/or account credentials of an account that the user holds. A device identifier may include a unique identifier assigned to a user device that can later be used to verify the user device. In some embodiments or aspects, the device identifier may include a device fingerprint. The device fingerprint may an aggregation of device attributes. The device fingerprint may be generated by a software development kit (SDK) provided on the user device using, for example, a unique identifier assigned by the operating system, an International Mobile Station Equipment Identity (IMEI) number, operating system (OS) version, plug-in version, and the like.

Various aspects of the present disclosure provide a payment card comprising two discrete or more contactless payment circuits associated with different primary account numbers (PANs). The payment card may conform to physical characteristics as defined by International Electrotechnical Commission (IEC) 7810, “Identification cards—Physical characteristics”, that defines a standard payment card thickness between 0.68 millimeters (0.027 in) minimum and 0.84 millimeters (0.033 in) maximum. The contactless payment circuits wirelessly transmits PAN information to a point of sale (POS) terminal enabling an end-user engage in a payment transaction with a merchant. The payment card further comprises two switches, a first switch on a first side of the payment card associated with a first contactless payment circuit and a second switch on a second side of the payment card associated with a second contactless payment circuit. The first switch and second switch are configured to detect a user input by an end-user and dynamically activate the first contactless payment circuit associated with the first PAN or the second contactless payment circuit associated with the second PAN.

Each switch comprises a set of two contact points, sufficiently spaced such that an end-user may complete the circuit with a single user input (e.g., contact by a single finger). Additionally, the first switch and the second senor are on opposite sides and opposite ends of the card making it difficult to inadvertently active both contactless payment circuits at the same time. The payment card may be configured such that only one contactless payment circuit is active at a time, to prevent inadvertent payment from the alternate PAN.

The set of contact points may be embossed, flush, or recessed to the surface of the payment card. In one aspect, the end-user must squeeze their finger firmly against the designated contact point such that their finger conforms to the contact points. In one aspect, recessed contact points may prevent inadvertent activation of a contactless payment circuit and ensure that the contactless payment circuit is only activated by intentional contact.

In one aspect the present disclosure provides a single payment card comprising multiple payment account numbers and more particularly, the present disclosure provides a single payment card comprising two payment account numbers. The payment card is configured to meet the physical characteristics of a payment card format ID-1 defined by IEC 7810, such that it may be used with payment card readers of a point-of-sale terminal. Although, the payment card may comprise multiple PANs the thickness of the payment card is within a standard thickness range defined by IEC 7810, for example.

The present disclosure additionally provides improved security for contactless payment circuits over traditional contactless payment circuits in payment cards. In various aspects, the contactless payment circuits are open circuits and inactive without a physical user input. Accordingly, a malicious actor cannot surreptitiously steal PAN account information through near filed communication (NFC) or other short range wireless communication medium while the payment card is in the end-user's wallet. Security concerns associated with NFC contactless payment has spawned an industry of radio frequency (RF) blocking wallets to prevent PAN account information theft. In one aspect, the payment card may be configured as a single payment card associated with a single PAN and one contactless payment circuit, such that the contactless payment circuit comprises a switch that renders the circuit open until the circuit is completed by a user input.

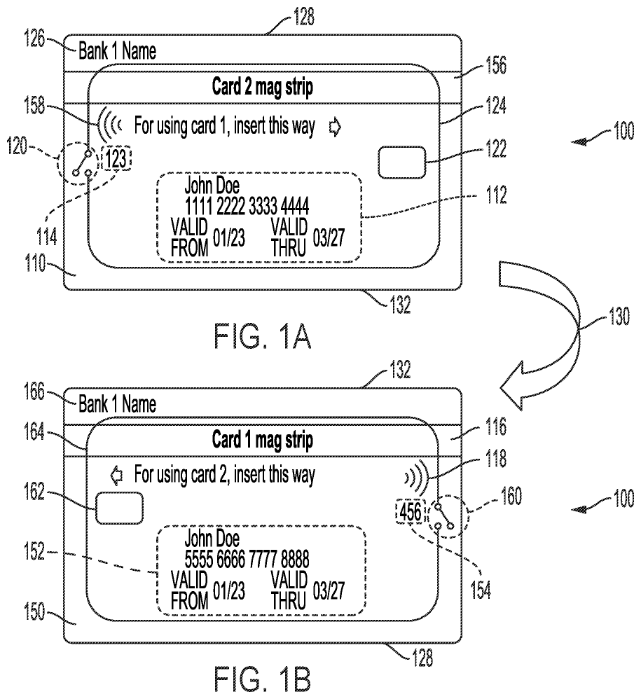

FIGS. 1A and 1B illustrate a single payment card 100 comprising two payment accounts, according to at least one aspect of the present disclosure. FIG. 1A illustrates a first side 110 of the payment card 100 and FIG. 1B illustrates a second side 150 of the payment card 100. FIG. 1A illustrates the first side 110 of the payment card 100 with a first long edge 128. FIG. 1B illustrates the second side 150 as a flipped version of the payment card 100, as indicated by arrow 130, such that the first long edge 128 of the first side 110, as shown in FIG. 1A, is at the bottom of the second side 150 as shown in FIG. 1B. In another aspect, the payment card 100 may be configured such that the first side 110 and the second side 150 are situated in the same orientation on opposite sides of the payment card 100.

The first side 110 of the payment card 100 is associated with a first primary account number 112 (PAN) and the second side 150 of the payment card 100 is associated with a second PAN 152. The account details for the first PAN 112 are shown on the first side 110 and the account details for the second PAN 152 are shown on the second side 150. In various aspects, the account details of the first PAN 112 and the second PAN 152 may be embossed, recessed, or flush to the surface of the payment card 100. The first side 110 further comprises a first EMV chip 122 (where EMV stands for Europay, Mastercard, and Visa) associated with the first PAN 112 and second side 150 further comprises a second EMV chip 152 associated with the first PAN 152.

Many payment cards that are associated with a single PAN display a credit code verification (CCV) number on the opposite side of the payment card from the PAN account details. However, a payment card with two PANs 112, 152 may create confusion for identifying the corresponding CCV for the PAN. In one aspect, the CCV for each PAN may be displayed on the same side as the PAN account details. Accordingly, the first CCV 114 associated with the first PAN 112 is displayed on the side one 110 and the second CCV 154 associated with the second PAN 152 is displayed on the side two 150. In another aspect, the CCV for each PAN may be displayed on the opposite side as the PAN account details accompanied by an identifier to prevent PAN confusion.

FIGS. 1A and 1B further illustrate a payment card 100 comprising two magnetic strips, a first magnetic strip 116 associated with the first PAN 112 and a second magnetic strip 156 associated with the second PAN 152. Due to the directional nature of the card 100, the first magnetic strip 116 associated with the first PAN 112 is disposed on the second side 150 of the payment card 100. Additionally, the second magnetic strip 156 associated with the second PAN 152 is disposed on first side 110 of the payment card 100. In various aspects, the magnetic strip may be color coordinated or labeled with the corresponding PAN card side to indicate to an end-user which magnetic strip is associated with which PAN. Additionally, the first magnetic strip 116 and the second magnetic strip 156 may be disposed on opposing ends (e.g., FIG. 1A first long edge 128 and FIG. 1B second long edge 132). In another aspect, the first magnetic strip 116 and the second magnetic strip 156 may be disposed along the same end (e.g., FIG. 1A first long edge 128 and FIG. 1B first long edge 128).

In various aspects, each side of the payment card 100 may display an affiliated bank, institution, or issuer associated with the PAN. In a non-limiting example, the first side 110 displays “Bank 1 Name” 126 associated with the first PAN 112 and the second side 150 displays “Bank 1 Name” 166 associated with the second PAN 152. In this example the first PAN 112 and the second PAN 152 are associated with the same institution. However, a single payment card may be associated with two PANs that correspond to two different financial institutions (e.g., the first PAN 112 may be associated with an account at a first financial institution and the second PAN 153 may be associated with an account at a second financial institution).

Additionally, FIGS. 1A and 1B illustrate the payment card comprising a first contactless payment circuit 124 corresponding to the first PAN 112 and a second contactless payment circuit 164 corresponding to the second PAN 152. The contactless payment circuits 124, 164 each comprise a near-filed communication (NFC) antenna 118, 158 and a switch 120, 160. The contactless payment circuits 124, 164 are embedded into the material of the payment card 100. In various aspects, the switch 120, 160 may be visible.

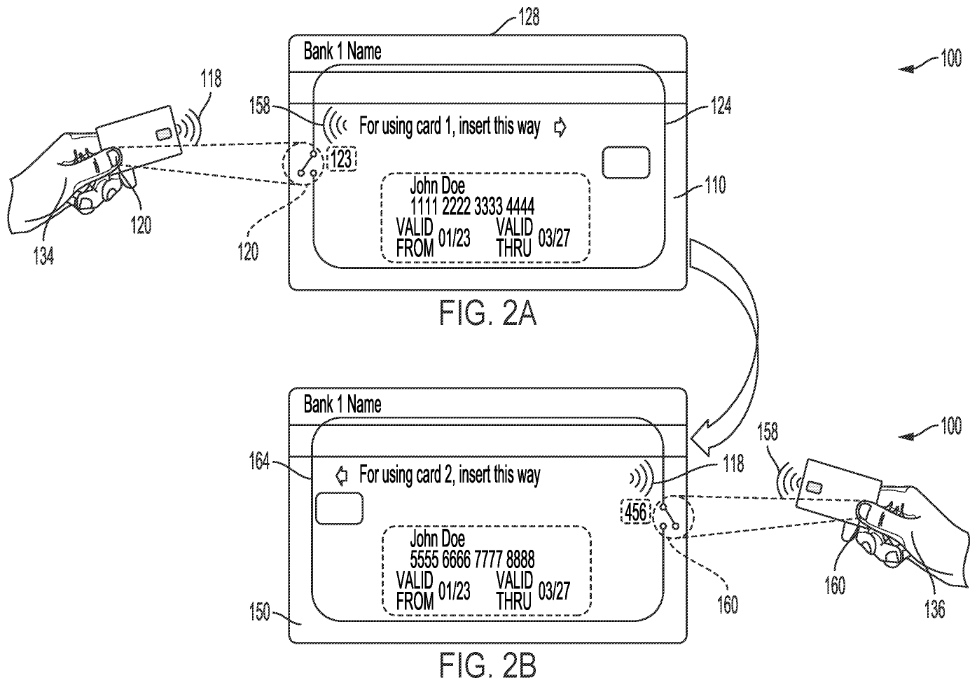

FIGS. 2A and 2B illustrate an end-user activating respective contactless payment circuits 124, 164 through the switches 120, 160, according to at least one aspect of the present disclosure. FIG. 2A illustrates an end-user 134 initiating a user input with the first switch 120 of the first contactless payment circuit 124 to electrically complete (e.g., close, short circuit, etc.) the first contactless payment circuit 124 and activate the first NFC antenna 118. FIG. 2B illustrates an end-user 136 initiating a user input with the second switch 160 of the second contactless payment circuit 164 to electrically complete (e.g., close, short circuit, etc.) the second contactless payment circuit 164 and activate the second NFC antenna 158. A contactless payment receiver for a POS terminal will be located underneath the payment card. Therefore, the first NFC antenna 118 may be disposed on the second side 150 of the payment card 100 and the second NFC antenna 158 may be disposed on the first side 110 of the payment card 100. This arrangement allows the end-user to initiate a user input with the switches 120, 160 and placing the NFC antennas 118, 158 near the contactless payment receiver of the POS terminal. In another aspect, the first NFC antennas 118 may be disposed on the first side 110 of the payment card 100 and the second NFC antenna 158 may be disposed on the second side 150 of the payment card 100.

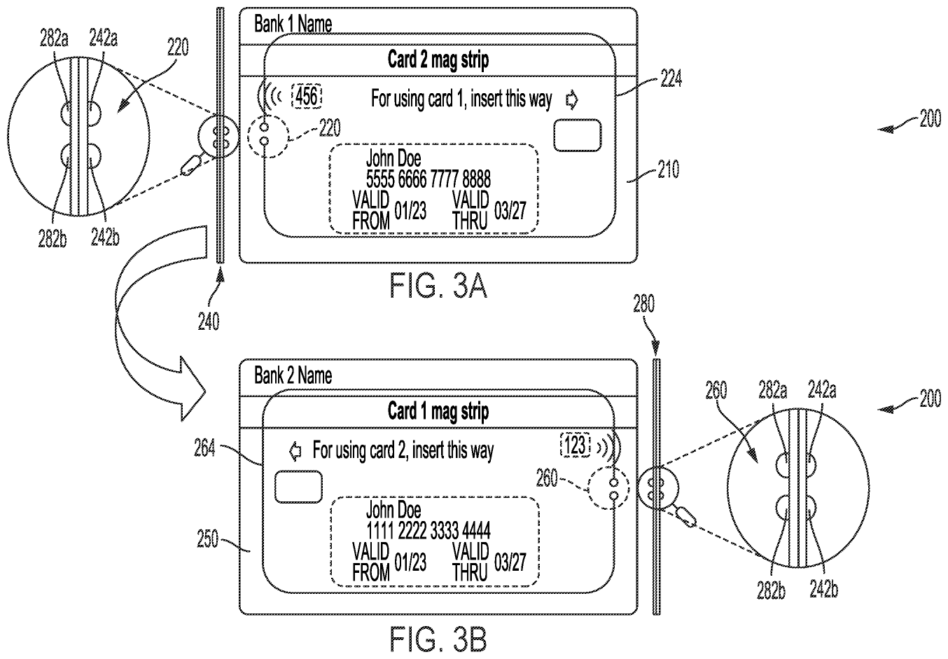

FIG. 3A illustrates a first short edge view 240 of a first side 210 of a payment card 200 with embossed contact points 242a, 242b, according to at least one aspect of the present disclosure. The first side 210 comprises a first switch 220 for a first contactless payment circuit 224. The first short edge view 240 illustrates the first switch 220 further comprising a first set of contact points 242a, 242b. The first set of contact points 242a, 242b is embossed on the surface of the payment card 200 such that an input by an end-user covers both contact points 242a, 242b and completes the first contactless payment circuit 224. The first short edge view 240 is shown relative to the left edge of the payment card 200 and shows the first set of contact points 242a, 242b larger than a second set of contact points 282a, 282b, to show relative distance.

FIG. 3B illustrates a second short edge view 280 of a second side 250 of a payment card 200 with embossed contact points 282a, 282b, according to at least one aspect of the present disclosure. The second side 250 comprises a second switch 260 for a second contactless payment circuit 264. The second short edge view 280 illustrates the second switch 220, 260 further comprising a second set of contact points 282a, 282b. The second set of contact points 282a, 282b is embossed on the surface of the payment card 200 such that an input by an end-user covers both contact points 282a, 282b and completes the second contactless payment circuit 264. The second short edge view 280 is shown relative to the right edge of the payment card 200 and shows the second set of contact points 282a, 282b larger than the first set of contact points 242a, 242b, to show relative distance.

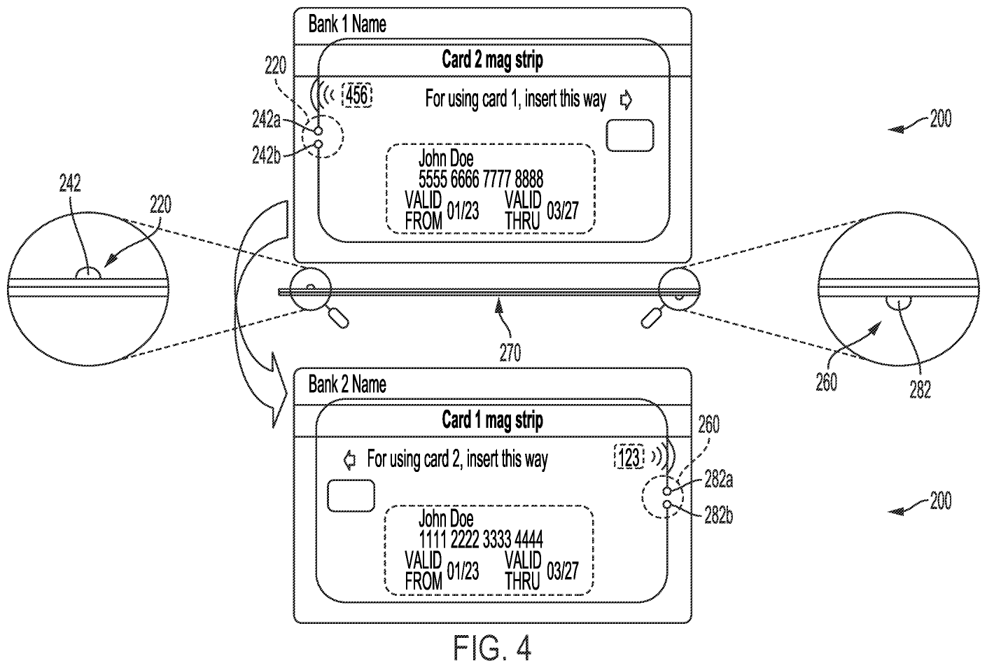

FIG. 4 illustrates a long edge view 270 of a payment card 200 with embossed contact points 242a, 242b, 282a, 282b for corresponding switches 220, 260 in contactless payment circuits, according to at least one aspect of the present disclosure. The long edge view 270 shows a first profile view 242 of the first set of contact points 242a, 242b of the first switch 220. Additionally, the long edge view 270 shows a second profile view 282 of the second set of contact points 282a, 282b of the second switch 260.

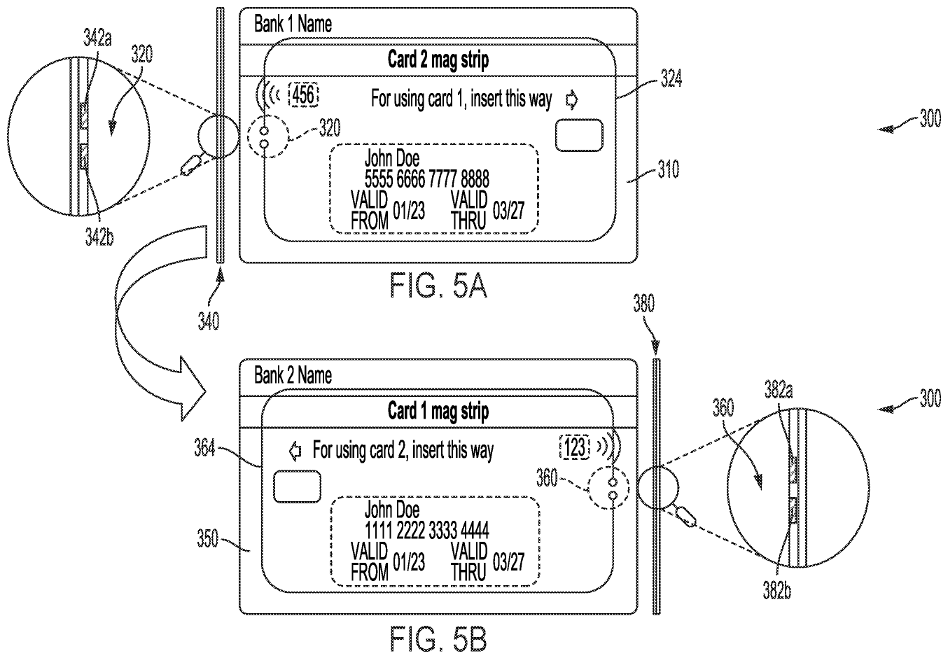

FIG. 5A illustrates a first short edge view 340 of a first side 310 of a payment card 300 with flush or recessed contact points 342a, 342b, according to at least one aspect of the present disclosure. The first side 310 comprises a first switch 320 for a first contactless payment circuit 324. The first short edge view 340 illustrates the first switch 320 further comprising a first set of contact points 342a, 342b. The first set of contact points 342a, 342b are flush or recessed to the surface of the payment card 300 such that an input by an end-user covers both contact points 342a, 342b and electrically completes (e.g., close, short circuit, etc.) the first contactless payment circuit 324.

FIG. 5B illustrates a second short edge view 380 of a second side 350 of a payment card 300 with flush or recessed contact points 382a, 382b, according to at least one aspect of the present disclosure. The second side 350 comprises a second switch 360 for a second contactless payment circuit 364. The second short edge view 380 illustrates the second switch 360 further comprising a second set of contact points 382a, 382b. The second set of contact points 382a, 382b is flush or recessed to the surface of the payment card 300 such that a user input by an end-user covers both contact points 382a, 382b and electrically completes (e.g., close, short circuit, etc.) the second contactless payment circuit 364.

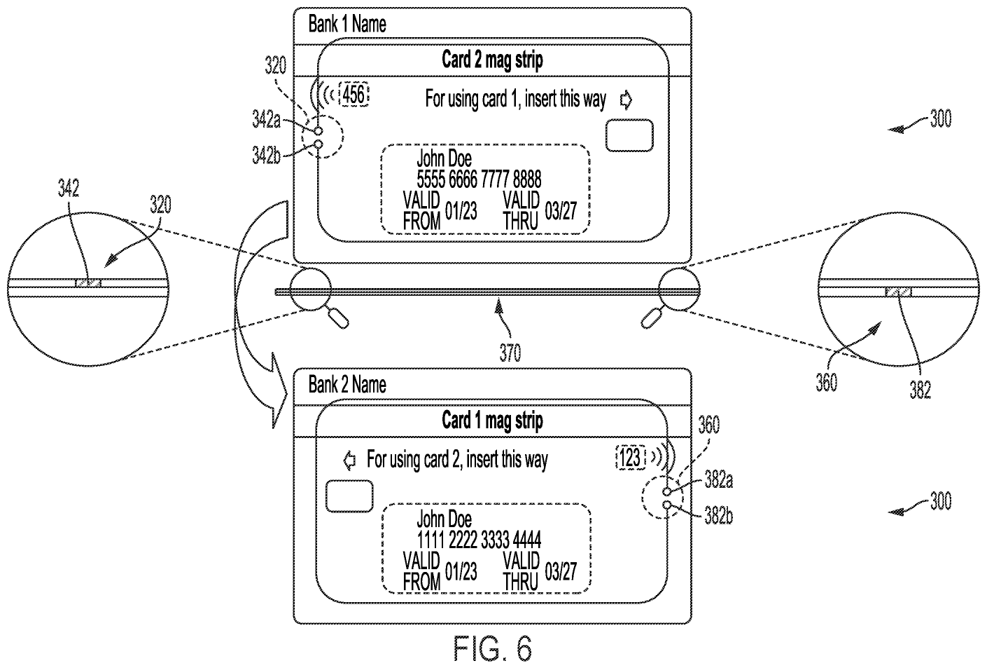

FIG. 6 illustrates a long edge view 370 of a payment card 300 with flush or recessed contact points for switches in contactless payment circuits, according to at least one aspect of the present disclosure. The long edge view shows a first profile view 342 of the first set of contact points 342a, 342b of the first switch 320. Additionally, the long edge view shows a second profile view 382 of the second set of contact points 382a, 382b of the second switch 380.

Examples of the method according to various aspects of the present disclosure are provided below in the following numbered clauses. An aspect of the method may include any one or more than one, and any combination of, the numbered clauses described below.

Clause 1. A payment card comprising: a first side associated with a first payment account; a second side associated with a second payment account; the first side comprising: a first primary account number (PAN) information is associated with the first payment account and displayed on a first side of the payment card, wherein the first PAN information corresponds to an end-user; a second magnetic strip corresponding to the second payment account; a first EMV (Europay, Mastercard, Visa) chip corresponding to the first PAN; and a first switch corresponding to a first contactless payment circuit for the first PAN, wherein the first contactless payment circuit is an open circuit at the first switch, wherein the first switch is configurable to electrically complete the first contactless payment circuit of the first payment account; the second side comprising: a second PAN information is associated with the second payment account and displayed on a second side of the payment card, wherein the second PAN information corresponds to the end-user; a first magnetic strip corresponding to the first payment account; a second EMV chip corresponding to the second PAN; and a second switch corresponding to a second contactless payment circuit for the second PAN, wherein the second contactless payment circuit is an open-circuit at the second switch, and wherein the second switch is configurable to electrically complete the second contactless payment circuit of the second payment account.

Clause 2. The payment card of Clause 1, wherein the first switch comprises a first set of contact points, and wherein the second switch comprises a second set of contact point.

Clause 3. The payment card of Clause 2, wherein the set of contacts points are spaced a distance such that a single finger of the end-user switch is capable of making simultaneous contact with both contact points in the set.

Clause 4. The payment card of Clause 2-3, wherein the set of contacts points are embossed on a surface of the first side or the second side.

Clause 5. The payment card of Clause 2-3, wherein the set of contact points are flush to a surface of the first side or the second side.

Clause 6. The payment card of Clause 2-3, wherein the set of contact points are recessed to a surface of the first side or the second side.

Clause 7. The payment card of Clauses 1-6, wherein a set of contact points is configured to detect a capacitive contact.

Clause 8. The payment card of Clauses 1-7, wherein a thickness of the payment card is between 0.68 millimeters and 0.84 millimeters.

Clause 9. The payment card of Clauses 1-8, wherein the first contactless payment circuit comprises a first near-field communication (NFC) antenna, and wherein the second contactless payment circuit comprises a second NFC antenna.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer readable medium, such as RAM, ROM, a magnetic medium such as a hard-drive or a floppy disk, or an optical medium such as a CD-ROM. Any such computer readable medium may reside on or within a single computational apparatus, and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December, 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A payment card comprising:
a first side associated with a first payment account;
a second side associated with a second payment account;
the first side comprising:
a first primary account number (PAN) information is associated with the first payment account and displayed on a first side of the payment card, wherein the first PAN information corresponds to an end-user;
a second magnetic strip corresponding to the second payment account;
a first EMV (Europay, Mastercard, Visa) chip corresponding to the first PAN; and
a first switch corresponding to a first contactless payment circuit for the first PAN, wherein the first contactless payment circuit is an open circuit at the first switch, wherein the first switch is configurable to electrically complete the first contactless payment circuit of the first payment account;
the second side comprising:
a second PAN information is associated with the second payment account and displayed on a second side of the payment card, wherein the second PAN information corresponds to the end-user;
a first magnetic strip corresponding to the first payment account;
a second EMV chip corresponding to the second PAN; and
a second switch corresponding to a second contactless payment circuit for the second PAN, wherein the second contactless payment circuit is an open-circuit at the second switch, and wherein the second switch is configurable to electrically complete the second contactless payment circuit of the second payment account.

2. The payment card of claim 1, wherein the first switch comprises a first set of contact points, and wherein the second switch comprises a second set of contact point.

3. The payment card of claim 2, wherein the set of contacts points are spaced a distance such that a single finger of the end-user switch is capable of making simultaneous contact with both contact points in the set.

4. The payment card of claim 2, wherein the set of contacts points are embossed on a surface of the first side or the second side.

5. The payment card of claim 2, wherein the set of contact points are flush to a surface of the first side or the second side.

6. The payment card of claim 2, wherein the set of contact points are recessed to a surface of the first side or the second side.

7. The payment card of claim 1, wherein a set of contact points is configured to detect a capacitive contact.

8. The payment card of claim 1, wherein a thickness of the payment card is between 0.68 millimeters and 0.84 millimeters.

9. The payment card of claim 1, wherein the first contactless payment circuit comprises a first near-field communication (NFC) antenna, and wherein the second contactless payment circuit comprises a second NFC antenna.
